(19) United States
(12) Patent Application Publication
(10) Pub. No.: US 2013/0041676 A1
(43) Pub. Date: Feb. 14, 2013

(54) System and Method for Overriding Claims

(71) Applicant: Paul M. Momita, San Diego, CA (US)

(72) Inventor: Paul M. Momita, San Diego, CA (US)

(73) Assignee: MEDIMPACT HEALTHCARE SYSTEMS, INC., San Diego, CA (US)

(21) Appl. No.: 13/207,203

(22) Filed: Aug. 10, 2011

(51) Int. Cl. G06Q 50/00

(52) U.S. Cl. 705/2

(57) ABSTRACT

Systems and methods for overriding claim denials and approvals are provided that determine that a current claim will be denied and search the purchasing member's claim history for previously approved claims that match the current claim. If a matching claim is found and is dated within a certain predetermined window of time, the current claim is approved. Additionally, when it is determined that a current claim will be approved at a high tier level the member's claim history is searched for a previously approved claim that matches the current claim and a formulary crosswalk analysis is performed. If a matching claim with a lower tier level is found in the member's claim history or the crosswalk analysis determines that a lower tier level is available, the current claim is processed using the lower tier. Claims overridden are digitally stamped for reporting purposes and for subsequent claim matching.

### BACKGROUND

1. Field of the Invention

The present invention relates generally to prescription drug benefits programs and more specifically relates to an improved claims adjudication system for adjudicating consumer purchases that are covered by such programs.

2. Related Art

Conventional systems for electronic claims adjudication by pharmacy benefits management (“PBM”) companies have been around for some time. A PBM is an administrator of prescription drug benefits programs. PBMs are primarily responsible for adjudication and paying claims for covered prescription drugs that are purchased by consumers who are members of the prescription drug benefits program. Other typical PBM services include developing and maintaining the drug formulary (the list of drugs covered by the prescription drug benefits program and their associated tiers), contracting with pharmacies, and negotiating discounts and rebates with drug manufacturers. Conventional PBM claim adjudication systems are typically employed when a member attempts to purchase a drug and the drug purchase is to be wholly or partially covered by a prescription drug benefits program. A prescription drug benefits program may be provided to the member through an employer health plan (e.g., ERISA plans, self insured employer group plans, managed care plans, Taft-Hartley trust plans, etc.), or a privately purchased health plan, a government sponsored health plan (e.g., Medicare, Medicaid or any other city, state or local or federal government plan) or directly from a PBM provider. In a drug purchase transaction, the originating entity (e.g., a pharmacy) electronically transmits a claim through a switch company to the PBM for adjudication of the claim. The PBM adjudicates the claim to validate, among other things, that the member prescription drug benefits program is valid, that the prescribing doctor is valid, and that the drug to be purchased is covered by the prescription drug benefits program. The PBM sends an electronic response back to the pharmacy that approves the transaction and identifies the co-pay amount or denies the transaction.

Periodically, prescription drug benefits programs may revise their formularies or revise certain utilization management (“UM”) rules that govern the processing of claims. A result of these revisions is that the changes typically cause subsequent claims to be denied that would have previously been approved. An additional result of such revisions is that they may cause subsequent claims to be approved at a higher cost to the member than would have previously been charged. Yet another result caused by such changes is that they may impose limitations on subsequent claims that were previously not present, for example, a limitation on the quantity of the drug being purchased. These claim denials, higher costs, and limitations are problematic in that they engender consumer frustration and disloyalty. Accordingly, what is needed is a system and method that overcomes these problems for the consumer in accordance with the design of the prescription drug benefits program.

### SUMMARY

Described herein are solutions to the problems described above that include systems and methods for overriding claim denials, higher cost claim approvals and newly imposed claim limitations in accordance with the design of the prescription drug benefits program. The systems and methods described herein operate within a PBM and allow drug prescription benefits program managers to efficiently change or revise formularies and utilization management rules in a fashion that appears seamless to members of the drug prescription benefits program.

Accordingly, and in accordance with the design of the prescription drug benefits program, when a current claim is being processed by the PBM, if it is determined that adjudication of the claim will result in a denied claim, the member's claim history is searched for previously approved claims that match the current claim. If a matching claim is found in the member's claim history and the matching claim is within a certain predetermined window of time, the claim is not denied and is instead approved. Claims thus approved are also digitally stamped as being overridden and stored in the member's claim history for reporting purposes and also for subsequent claim matching analysis.

Additionally, and in accordance with the design of the prescription drug benefits program, when a current claim is being processed by the PBM, if it is determined that the claim will be approved at a tier level that is higher than the lowest tier level, the member's claim history is searched for previously approved claims that match the current claim. If a matching claim with a lower tier level is found in the member's claim history and the matching claim with the lower tier level is within a certain predetermined window of time, the tier level of the current claim is overridden and the current claim is approved using the lower tier level. Approved claims with overridden tier levels are also digitally stamped as being overridden and stored in the member's claim history for reporting purposes and also for subsequent claim matching analysis.

Alternatively, and in accordance with the design of the prescription drug benefits program, when a current claim is being processed by the PBM, if it is determined that the claim will be approved at a tier level that is higher than the lowest tier level a crosswalk analysis of relative tier levels between the previous formulary and the current formulary is performed to determine if a more favorable tier level for the current claim was previously available to the member. If a lower tier level was previously available, the tier level of the current claim is overridden and the current claim is approved using the lower tier level. These approved claims with overridden tier levels are also digitally stamped as being overridden and stored in the member's claim history for reporting purposes and also for subsequent claim matching analysis.

Other features and advantages of the present invention will become more readily apparent to those of ordinary skill in the art after reviewing the following detailed description and accompanying drawings.

### BRIEF DESCRIPTION OF THE DRAWINGS

The structure and operation of the present invention will be understood from a review of the following detailed description and the accompanying drawings in which like reference numerals refer to like parts and in which:

FIG. 1 is a network diagram illustrating an example system for overriding claims during claim adjudication according to an embodiment of the invention;

FIG. 2 is a block diagram illustrating an example PBM according to an embodiment of the invention;

FIG. 3 is a high level flow diagram illustrating an example process for overriding a denied claim according to an embodiment of the invention;

FIG. 4 is a high level flow diagram illustrating an example process for overriding an approved claim according to an embodiment of the invention;

FIG. 5 is a flow diagram illustrating an example process for overriding a denied claim according to an embodiment of the invention;

FIG. 6 is a timeline diagram illustrating an example operation of an eligibility window and a lookback window according to an embodiment of the invention;

FIG. 7 is a flow diagram illustrating an example process for overriding the tier level of an approved claim according to an embodiment of the invention;

FIGS. 8A-8D are block diagrams illustrating examples of overriding the tier level of an approved claim according to an embodiment of the invention;

FIG. 9 is a block diagram illustrating an example computer system that may be used in connection with various embodiments described herein.

### DETAILED DESCRIPTION

Certain embodiments as disclosed herein provide systems and methods for overriding claims during claim adjudication that allows denied claims to be approved and allows approved claims to be adjudicated at a lower tier level based on an analysis of historical claim data and other criteria. For example, one method as disclosed herein allows for a denied claim to be approved when a matching claim is present in the member's claim history. Another method disclosed herein allows for an approved claim to be adjudicated at a lower tier level based upon a crosswalk analysis of relative tier levels between the previous formulary and the current formulary.

After reading this description it will become apparent to one skilled in the art how to implement the invention in various alternative embodiments and alternative applications. However, although various embodiments of the present invention will be described herein, it is understood that these embodiments are presented by way of example only, and not limitation. As such, this detailed description of various alternative embodiments should not be construed to limit the scope or breadth of the present invention as set forth in the appended claims.

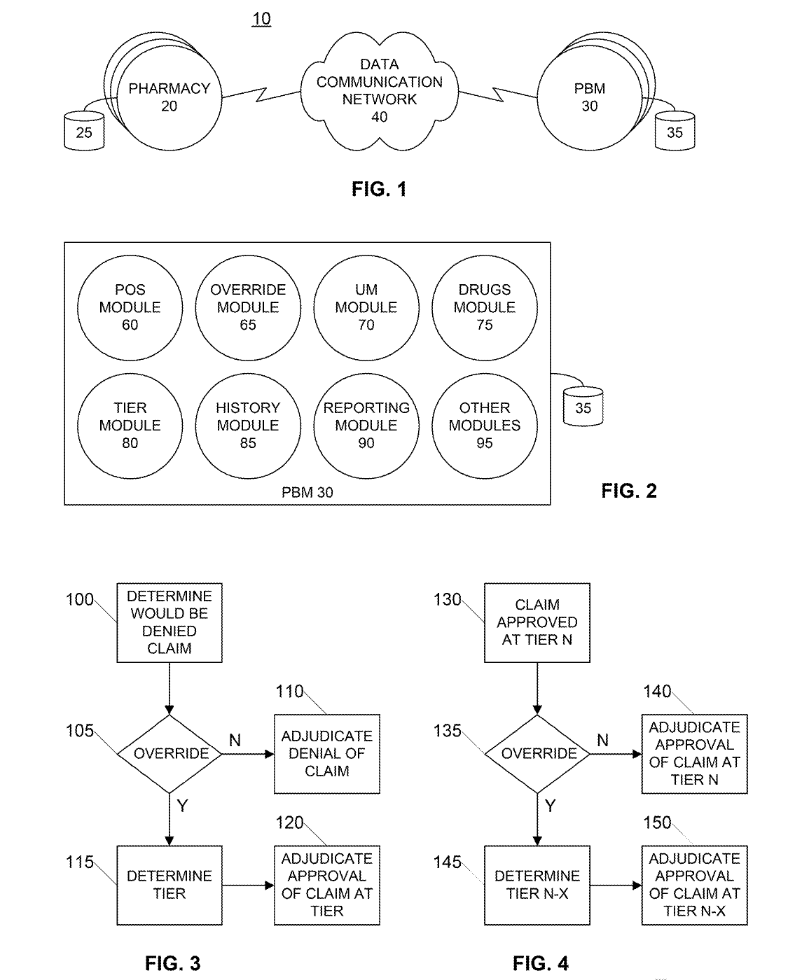

FIG. 1 is a network diagram illustrating an example system 10 for overriding claims during claim adjudication according to an embodiment of the invention. In the illustrated embodiment, the system 10 comprises a pharmacy 20 that is communicatively coupled with PBM 30 via a data communication network 40. The system 10 may include more than one pharmacy 20 and more than one PBM 30.

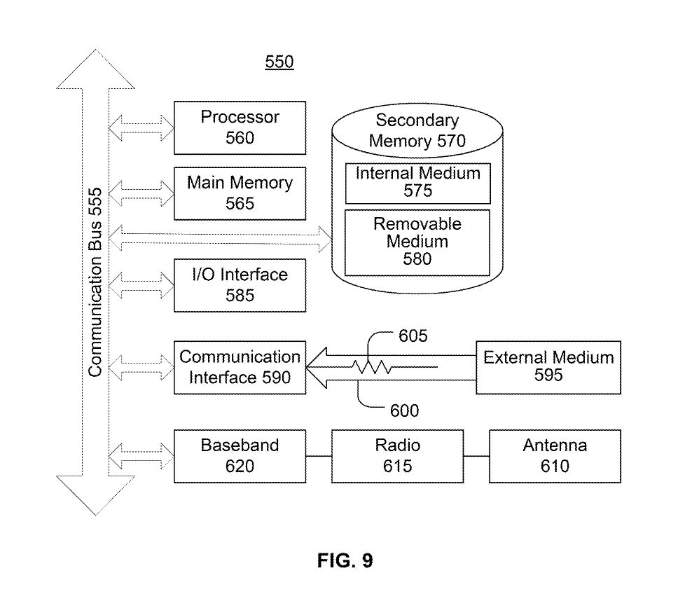

The pharmacy 20 can be a brick and mortar store, an online ecommerce website or application, or any other sort of entity, system or device that is capable of handling a member's prescription drug purchase transaction. The pharmacy 20 may include one or more processor enabled communication devices (not shown) that are capable of communicating with the PBM 30 over the network 40 and storing data in and retrieving data from the data storage area 25. The data storage area 25 may include any form of memory including volatile and non-volatile. In one embodiment, the data storage area 25 includes non-transitory computer readable media. Example architectures that can be employed for such communication devices are described later with respect to FIG. 9.

Similarly, the PBM 30 may include one or more processor enabled communication devices (not shown) that are capable of communicating with the pharmacy 20 over the network 40 and storing data in and retrieving data from the data storage area 35. The data storage area 35 may include any form of memory including volatile and non-volatile. In one embodiment, the data storage area 35 includes non-transitory computer readable media. Example architectures that can be employed for such communication devices are described later with respect to FIG. 9.

The network 40 may include a variety of communication infrastructure including direct wired connections, personal area networks, local area networks, wide area networks, metropolitan area networks and any other communication infrastructure including telephone networks and the Internet. The network 40 may be wired or wireless or a combination of wired and wireless and may also be capable of transmitting voice or data traffic or a combination of voice and data traffic. The network 40 may also be public or private or a combination of public and private and may transmit information using a variety of protocols, as will be understood by those skilled in the art.

In one embodiment, the data communication network 40 includes a switch (not shown) that operates in the communication infrastructure between the pharmacy 20 and the PBM 30 and serves to electronically route prescription drug purchase claims to the appropriate PBM 30 based on member provided information (e.g., a prescription drug benefits program card or other eligibility data or evidence of coverage).

In operation of the system 10, a member of a prescription drug benefits program attempts to purchase a prescribed drug at the pharmacy 20. The pharmacy 20 collects certain information from the member to validate the prescription drug purchase transaction (also referred to herein as a “claim”). For example, this information may be obtained from the member's prescription drug benefits program card or health plan card. The pharmacy 20 sends an electronic claim adjudication request to the PBM 30 via the network 40. The claim adjudication request seeks approval of the drug purchase transaction from the PBM 30. The PBM 30 adjudicates the claim based on this request to validate or determine various elements related to the claim. For example, the elements related to the claim may include enrollment status of the member in the prescription drug benefits program, other member information, inclusion of the drug to be purchased on the formulary, the quantity of the drug to purchased, the amount of the member copay, benefit design, pharmacy network and any UM restrictions, etc.

During claim adjudication, the PBM 30 analyzes information relevant to the particular claim being adjudicated. During the analysis, the PBM 30 determines whether the claim will be denied or approved and if it will be approved the PBM 30 also determines the tier at which the claim will be adjudicated. If the claim will be denied, the PBM 30 also determines if the denial of the claim will be overridden. If the claim will be approved, the PBM 30 also determines if the tier level will be overridden. Upon completion of the claim adjudication process the PBM 30 provides the results of the claim adjudication to the pharmacy 20 in response to the claim adjudication request.

FIG. 2 is a block diagram illustrating an example PBM 30 according to an embodiment of the invention. In the illustrated embodiment, the PBM 30 comprises a point of sale (“POS”) module 60, an override module 65, a UM module 70, a drugs module 75, a tier module 80, a history module 85, a reporting module 90, and one or more additional modules 95 as needed by the PBM 30. As previously discussed, the PBM 30 includes a processor enabled communication device and this device is capable of accessing information and the various modules of the PBM 30 that are stored in data storage area 35 and executing those modules using the processor. Additionally, each of the various modules of the PBM 30 are configured to store information and data in the data storage area 35 and otherwise manage information and data that is related to each module's respective operation. The various modules of the PBM 30 can also be configured for direct (e.g., interprocess communication) and indirect (e.g., shared memory) communication with other modules of the PBM 30 or external modules and/or devices.

In one embodiment, the point of sale (“POS”) module 60 is configured to receive a claim adjudication request, adjudicate the claim, and provide claim adjudication results in response to the claim adjudication request. The POS module 60 receives a claim adjudication request from a pharmacy (not shown) via a communication link. The PBM 30 may include one or more other modules 95 that manage the communication link and its corresponding physical media (e.g., wired or wireless networks, direct cable connections, modems, etc.). Similarly, the POS module 60 provides the claim adjudication results to a pharmacy via a communication link that may be managed by the one or more other modules 95 stored in memory 35 of the PBM 30. In one embodiment, there is a switch operating in the communication infrastructure between the pharmacy and the PBM 30 and in such an embodiment, the POS module 60 receives the claim adjudication request indirectly from the pharmacy through the switch and provides the claim adjudication results indirectly to the pharmacy through the switch.

During claim adjudication, the POS module 60 communicates with a variety of modules on the PBM 30 and accesses information and data stored in the data storage area 35 in order to manage the overall claim adjudication process. For example, the POS module 60 may communicate with the override module 65 to determine if a denied claim will be overridden and may communicate with the history module to obtain historical claim data that is stored in the data storage area 35. As will be understood by those skilled in the art, the various functions of the POS module 60 (and the other modules of the PBM 30) can alternatively be implemented as stand alone modules or separated or combined as desired to increase efficiency, lower costs, etc. In one embodiment, the POS module 60 maintains and manages information related to the lookback window and eligibility window that are used by the override module 65 when determining whether or not to override a denied claim or change the tier of an allowed claim.

The override module 65 is configured to determine if a claim that would otherwise be denied (a “would be denied claim”) will be overridden. In one embodiment, the override module 65 receives a request from the POS Module 60 to determine if a would be denied claim is to be overridden. If the claim is a would be denied claim, the override module 65 is configured to determine if the would be denied claim is to be denied because the requested drug is not currently available on the formulary (also referred to as “non-formulary”) or because of a restriction that is in place (also referred to as a utilization management restriction, or (“UM restriction”). UM restrictions may include, but are not limited to, quantity limits (“QL”), step therapy (“ST”) and prior authorization (“PA”). Other UM restrictions may also be employed, as will be understood by those skilled in the art.

In one embodiment, the override module 65 communicates with the UM module 70 or the drugs module 75 to determine if the current would be denied claim is to be denied as non-formulary or due to a UM restriction. If a would be denied claim is to be denied as non-formulary, the override module 65 communicates with the history module 85 to determine if the member has a recent transaction in which the non-formulary drug was purchased. Advantageously, the meaning of recent can be provided to the override module 65 by the POS Module 60 based upon a lookback window that is managed by the POS Module 60 that determines, for example, how may days back the lookback window extends. In one embodiment, the lookback window is 120 days. Accordingly, the override module 65 determines if the prior purchase of the non-formulary drug by the member was within the last 120 days. If it was, then the override module 65 informs the POS Module 60 that the would be denied claim is to be overridden.

Similarly, if the would be denied claim is to be denied for a UM restriction, the override module 65 communicates with the history module 85 to determine if the member has a recent transaction in the claims history in which the drug was purchased without the UM restriction. For example, the current claim may require a prior authorization for purchase by the member. Accordingly, the override module 65 determines if the drug was previously purchased by the member without prior authorization and within the lookback window time period. If it was, then the override module 65 informs the POS Module 60 that the would be denied claim is to be overridden.

Additionally, the override module 65 is configured to determine if an allowed claim will be overridden. In one embodiment, the override module 65 receives a request from the POS Module 60 to determine if an allowed claim is to be overridden. If the claim is an allowed claim, the override module 65 is configured to determine the tier at which the allowed claim is to be adjudicated. The override module 65 may communicate with the history module 85 to determine if the member has a recent transaction in which the drug was purchased at a different tier. In one embodiment, if the different tier in the member's transaction history is an improved tier, then the override module 65 informs the POS Module 60 that the allowed claim is to the overridden and adjudicated at the improved tier.

In an embodiment where there have been modifications or a complete change in the formulary, the override module 65 is configured to communicate with the tier module 80 to determine if an allowed claim can be adjudicated using a different (e.g., improved) tier. For example, the override module 65 may request that the tier module 80 provide a best case tier and if the best case tier is the same as the tier of the allowed claim, then the allowed claim is not overridden. If the best case tier is an improvement over the tier of the allowed claim then the override module 65 informs the POS Module 60 that the allowed claim is to be overridden and adjudicated at the best case tier. In alternative embodiments, whether the best case tier is an improvement can be determined with respect to the member or with respect to the prescription drug benefits program.

The override module 65 may also maintain and manage information related to the granular application of non-formulary overrides on a drug-by-drug or member-by-member basis. Advantageously, this allows the override module 65 to determine if denied claims should be overridden on a granular basis by drug, by member or any combination of these and other factors.

The UM module 70 is configured to facilitate determinations regarding overriding denied claims. In one embodiment, the UM module 70 communicates with the override module 65 and provides the override module 65 with information regarding past and current UM restrictions including QL, ST and PA restrictions. The UM module 70 may also maintain and manage a list of UM restrictions and information related to the granular application of UM restriction overrides on a drug-by-drug or member-by-member or restriction-by-restriction basis. Advantageously, this allows the UM module 70 to determine if denied claims should be overridden on a granular basis by restriction, by drug, by member or any combination of these and other factors.

The drugs module 75 is configured to maintain information in the data storage area 35 about the drugs in the formulary as well as drugs not in the formulary. For example, the drugs module 75 may maintain in data storage area 35 the national drug code (“NDC”) listing of prescription drugs and their corresponding therapeutic classes and prices. During claim adjudication, the drugs module 75 may be called upon to obtain information related to the drug or drugs associated with the claim adjudication request. This information can be used by the POS module 60 to confirm that the requested drug is approved for purchase (i.e., in the formulary) and also to determine the member price to be paid, for example when the tier level of the drug suggests that the member copay is a percentage of the price of the drug, e.g., with co-insurance or otherwise. The drugs module 75 may also maintain a list of drugs that were previously available in a prior version of the prescription drug benefits plan formulary. This information can be used by the override module 65 to determine if the requested drug to be purchased is eligible for an override of a claim denial because the requested drug is not in the current formulary. Accordingly, the system may determine whether or not a particular drug was previously available based on an examination of prior formulary information or based on an examination of prior claims history, or any combination of the two, as will be understood by those skilled in the art.

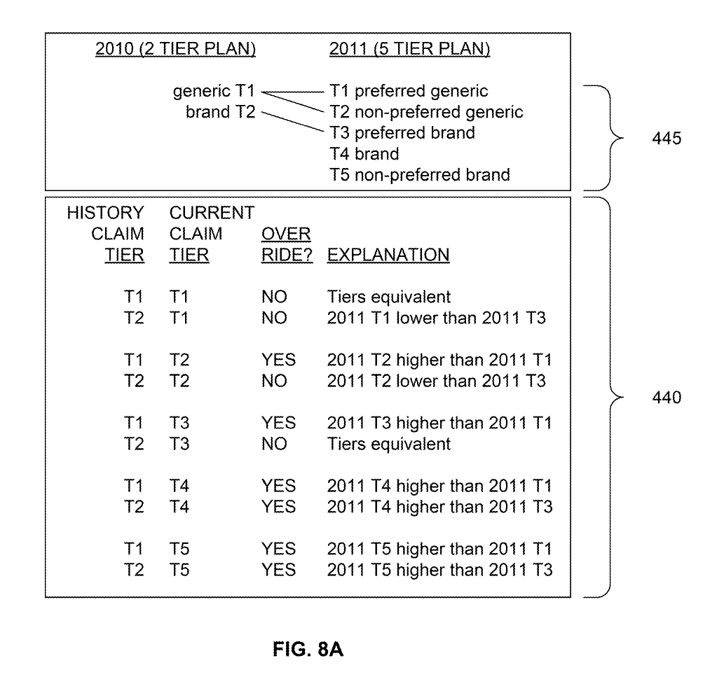

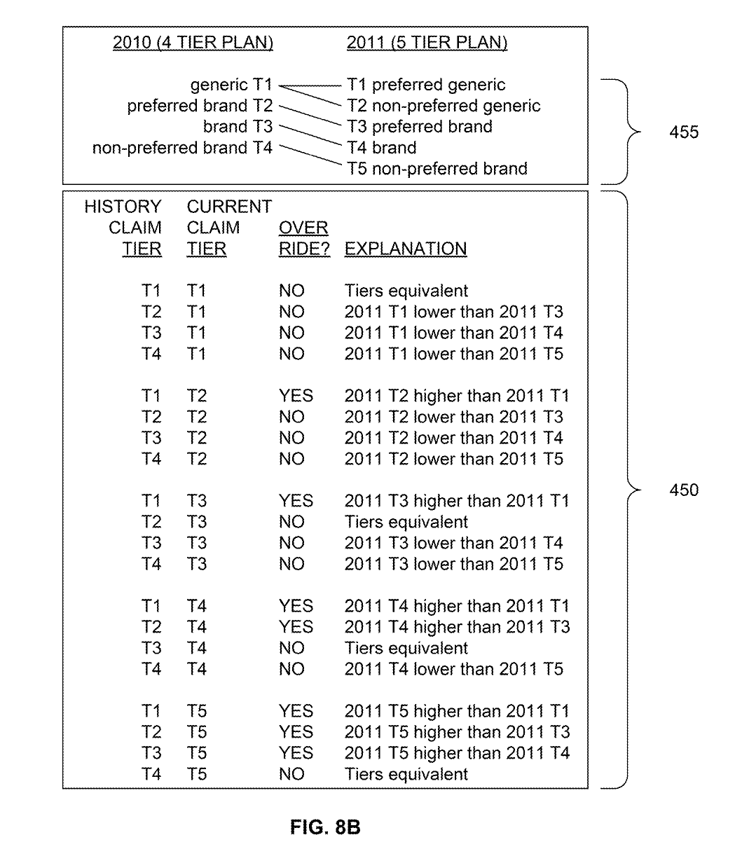

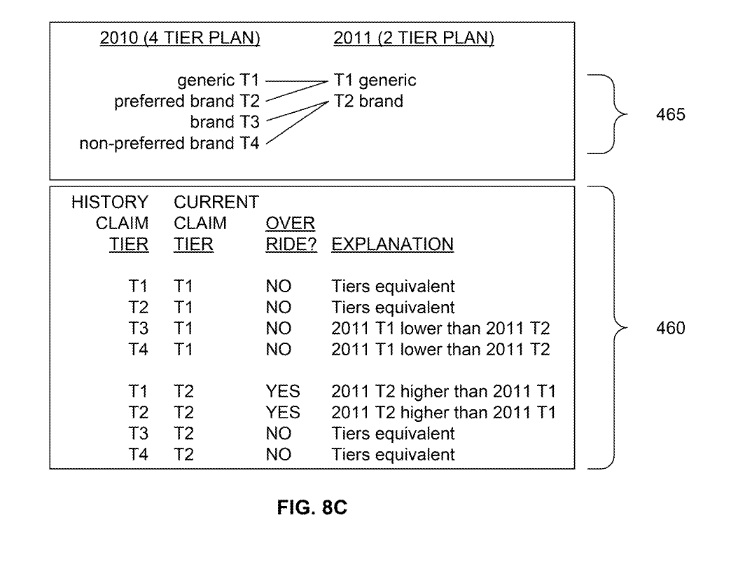

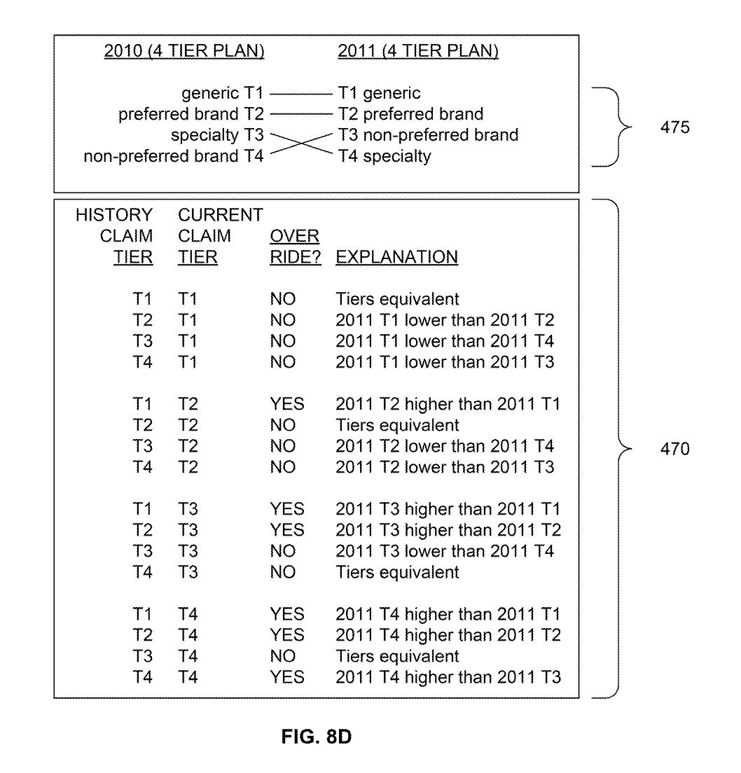

The tier module 80 is configured to determine a best case tier for a given drug purchase transaction. For example, tier module 80 implements a tier crosswalk that analyzes the effect of formulary changes on a given drug purchase transaction. Accordingly, the tier module 80 determines if the best case tier for a given transaction using two or more alternative formularies. Examples of such analyses by the tier module 80 are described later with respect to FIGS. 8A-8D.

The history module 85 is configured to provide historical transaction data to the override module 65 and any other modules requesting such information. In one embodiment, the history module 85 is configured to provide the historical transaction data provided in response to a request after filtering the historical transaction data using the lookback window. Accordingly, the history module 85 can provide only that information that needs to be considered by the override module 65 (or other modules) when determining whether to override the current claim.

The reporting module 90 is configured to access information stored in data storage 35 and is also configured to communicate with the various modules of PBM 30 in order to provide data and feature-rich reports to the various stakeholders that are involved in the implementation of a prescription drug benefits program. In one embodiment, the reporting module 90 is configured to provide information regarding the denied claims that overridden and allowed and the allowed claims that were overridden so as to be adjudicated at a lower tier level. In one embodiment, the POS module 60 may communicate with the reporting module 90 to provide the reporting module 90 with information related to claim adjudication results that can be incorporated by the reporting module 90 into informational reports provided to the PBM 30, the prescription drug benefits program administrator, the pharmacy, or even the member.

Other modules 95 can also be included in the PBM 30 as will be understood by those skilled in the art. Other modules 95 may incorporate a portion of the functionality ascribed to modules 60-90 and may also provide additional functionality to facilitate operation of the PBM 30.

FIG. 3 is a high level flow diagram illustrating an example process for overriding a would be denied claim according to an embodiment of the invention. In one embodiment, the illustrated process can be implemented by the system previously described with respect to FIGS. 1 and 2. Initially, in step 100 the system determines that a member's drug purchase claim is a would be denied claim. Next, in step 105, the system determines whether or not the would be denied claim will be overridden. In step 110, if the would be denied claim will not be overridden, the system adjudicates the would be denied claim as denied. However, in step 115 if the would be denied claim will be overridden (as determined in step 105), the system determines the tier at which the would be denied claim will be adjudicated as allowed and then in step 120 the system adjudicates the approval of the would be denied claim in accordance with the determined tier. Advantageously, when a would be denied claim is overridden, the would be denied claim is digitally stamped as being overridden and stored in the claim history for reporting purposes and also for subsequent claim matching analysis.

FIG. 4 is a high level flow diagram illustrating an example process for overriding an approved claim according to an embodiment of the invention. In one embodiment, the illustrated process can be implemented by the system previously described with respect to FIGS. 1 and 2. Initially, in step 130 the system determines that a member's drug purchase claim will be approved and adjudicated at tier N. Next, in step 135, the system determines whether or not the tier level of the claim will be overridden. In step 140, if the tier level of the claim will not be overridden, the system adjudicates the approval of the claim at tier level N. However, in step 145 if the tier level of the claim will be overridden (as determined in step 135), the system determines the new tier at which the claim will be adjudicated (e.g., tier N−X) and then in step 150 the system adjudicates the approval of the claim in accordance with the determined tier (e.g., tier N−X). In one embodiment the new tier for the transaction may have a higher numerical tier value than tier N (e.g., N+X), due to changes in benefit design, but would have an equivalent to lower cost in real dollars to the member. Advantageously, when an allowed claim is overridden, the allowed claim is digitally stamped as being overridden and stored in the claim history for reporting purposes and also for subsequent claim matching analysis.

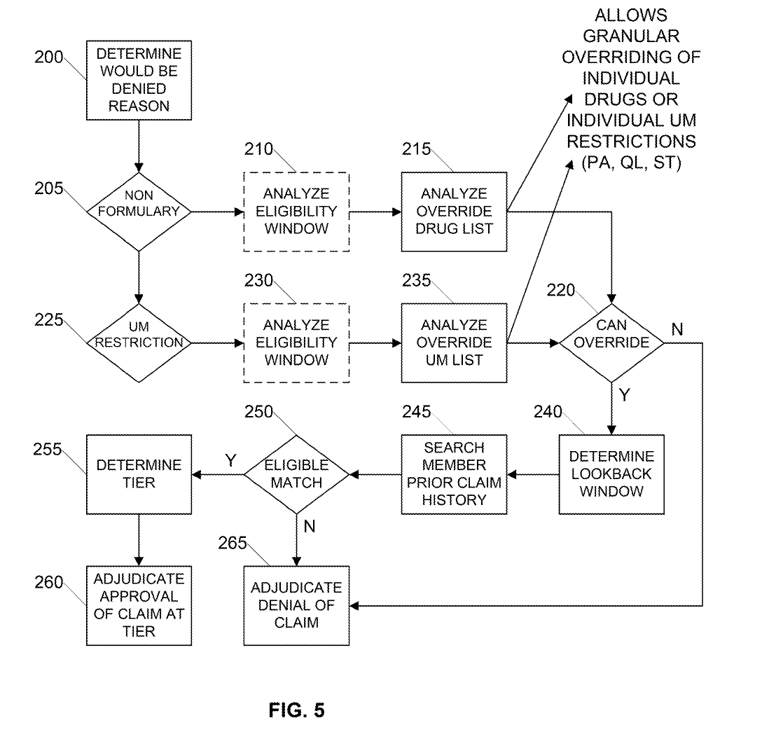

FIG. 5 is a flow diagram illustrating an example process for overriding a denied claim according to an embodiment of the invention. In one embodiment, the illustrated process can be implemented by the system previously described with respect to FIGS. 1 and 2. Initially, in step 200 the system determines the reason that a claim was denied. For example, a claim may be denied for a variety of reasons such as the prescribing doctor is not valid, the drug is not listed in the formulary, the quantity to be purchased exceeds the quantity limit, the required prior authorization to purchase the drug is not present, or the member attempting to purchase the drug is non-compliant with a prescribed therapy plan. It should be noted that not all reasons for claim denial can be overridden. However, as determined in steps 205 and 225, if a claim is denied because the drug is non-formulary or because of a UM restriction, the system proceeds to determine if the denied claim should be overridden.

Accordingly, if a claim is denied because the drug is non-formulary as determined in step 205, in step 210 the system analyzes the eligibility window. This step is advantageously optional. For example, some prescription drug benefits programs may want formulary changes to always be capable of being overridden. However, when formulary changes are only desired to be overridden during a certain transition period, in step 210 the system analyzes the eligibility window to determine if the formulary change that resulted in the denial of the claim took place within the eligibility window. Next, in step 215 the system analyzes the override drug list to determine if the specific drug attempting to be purchased is available for being overridden. Advantageously, this allows very granular overriding of claims on an individual drug basis.

After analyzing the eligibility window and any drug specific information, in step 220 the system determines if the claim can be overridden. For example, if the formulary change did not take place within the eligibility window or the drug attempting to be purchased is excluded from being overridden, the system proceeds to step 265 and adjudicates the denial of the claim. However, if the formulary change did take place within the eligibility window or the drug attempting to be purchased is not excluded from being overridden, then the system proceeds to step 240.

Turning back to step 225, if a claim is denied because of a UM restriction, in step 230 the system similarly optionally analyzes the eligibility window of the UM restriction and then in step 235 the system analyzes any UM restriction specific information that is related to overrides. Advantageously, this allows the system to override claim denials at in a very granular fashion, for example on a restriction-by-restriction or member-by-member or drug-by-drug basis. Next, in step 220 the system determines if the claim can be overridden. For example, if the UM restriction was not implemented within the eligibility window or the UM restriction is excluded from being overridden, the system proceeds to step 265 and adjudicates the denial of the claim. However, if the UM restriction was implemented within the eligibility window or the UM restriction is not excluded from being overridden, then the system proceeds to step 240.

Whether the claim was denied for a UM restriction or as being non-formulary, once the system has initially determined that the claim can be overridden, in step 240 the system determines the lookback window. The lookback window is the period going back in time during which an approved claim in the member's claim history can result in the current denied claim being overridden. For example, the lookback window may be a certain number of days, such as 30, 60, 90 or 120 days. The lookback window can be stored in memory as a configurable parameter that the administrator of the drug purchase benefits program can set and modify as desired. Accordingly, in step 240 the system determines the lookback window.

Next, in step 245 the system searches the member's prior claim history for an approved claim within the lookback window. If a matching claim is not found in the member's prior claim history, as determined in step 250, then the system proceeds to step 265 and adjudicates the denial of the claim. If a matching claim is found in the member's prior claim history, as determined in step 250, the tier for the current claim is determined in step 255 and then the system adjudicates approval of the claim at the determined tier as illustrated in step 260. Advantageously, when a claim is overridden the claim is digitally stamped as being overridden for reporting purposes and also for subsequent claim matching analysis.

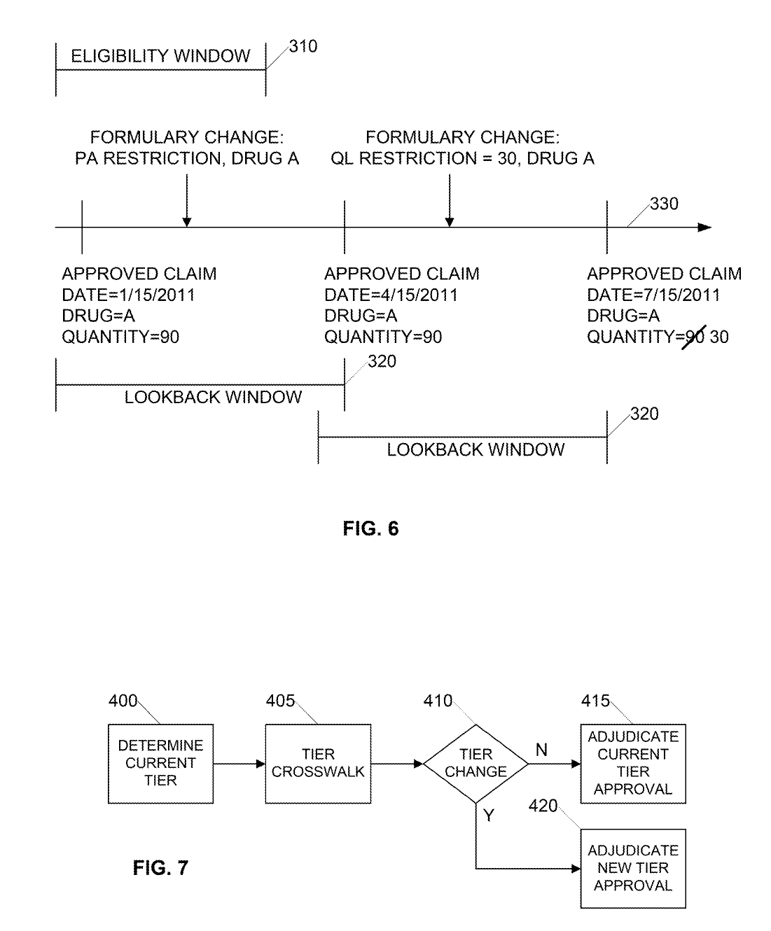

FIG. 6 is a timeline diagram illustrating an example operation of an eligibility window 310 and a lookback window 320 according to an embodiment of the invention. In the illustrated embodiment, the eligibility window 310 spans an initial portion of the timeline 330 and there are two lookback windows 320. For this example embodiment, the lookback window is set to be 100 days. There are also five events along the timeline. The first event is an approved claim. The claim was approved on Jan. 15, 2011 for the purchase of drug A with a quantity of 90. The second event is a formulary change for drug A. The formulary change introduces a UM restriction that requires prior authorization to purchase drug A. The prior authorization formulary change is within the eligibility window 310. The third event is an approved claim. The claim was approved on Apr. 15, 2011 for the purchase of drug A with a quantity of 90. Although not shown, there is no prior authorization for this approved claim. The fourth event is a formulary change for drug A. The formulary change introduces a UM restriction that imposes a quantity limit of 30 for the purchase of drug A. The quantity limit formulary change is not within the eligibility window 310. The fifth event is an approved claim. The claim was approved on Jul. 15, 2011 for the purchase of drug A with an initial requested quantity of 90, approved for a quantity of 30.

In operation, the first claim for the purchase of drug A is approved on Jan. 15, 2011. This claim is not stamped having been overridden. Next, the PA formulary change is made during the eligibility window. Accordingly, would be denials of future claims for the purchase of drug A without prior authorization can be overridden if supporting data is available to justify the overriding of the future would be denied claim. Next, when the Apr. 15, 2011 claim is analyzed, it is identified as a would be denied claim for lack of prior authorization. However, the system determines that the formulary change to require prior authorization took place during the eligibility window so the system analyzes the member's claim history to see if the member had previously purchased drug A without prior authorization. In this case, the claim history for the member shows the approved claim from Jan. 15, 2011 that is within the 100 day lookback window. Because the approved claim from Jan. 15, 2011 was within the lookback window and did not require prior authorization, the Apr. 15, 2011 would be denied claim is overridden and approved. The approved Apr. 15, 2011 claim is also digitally stamped as being overridden with respect to the PA restriction and stored in the claim history for reporting purposes and also for subsequent claim matching analysis.

Next, the QL formulary change is made after the eligibility window closes and subsequently a new claim is submitted on Jul. 15, 2011. When the Jul. 15, 2011 claim is analyzed, it is identified as a would be denied claim for lack of prior authorization. However, the system determines that the formulary change to require prior authorization took place during the eligibility window so the system analyzes the member's claim history to see if the member had previously purchased drug A without prior authorization within the lookback window or has an existing override claim within the lookback window. For example, the system searches through historical transaction data for an approved claim with matching characteristics (e.g., same drug) that has been digitally stamped as being overridden with respect to the PA restriction. In one embodiment, a set of parameters for the current claim are determined and compared to parameters of claims in the claim history and matching claims are identified when a certain threshold (e.g., predetermined or dynamically determined) of matches in the current claim parameters and the historical claim parameters is met. In this case, the claim history for the member shows the approved claim from Apr. 15, 2011 that was digitally stamped as being overridden with respect to the PA restriction. Because the approved claim from Apr. 15, 2011 is digitally stamped as being overridden with respect to the PA restriction and is within the 100 day lookback window, the current Jul. 15, 2011 would be denied claim is overridden and approved with respect to the PA restriction. The approved Jul. 15, 2011 claim is also digitally stamped as being overridden with respect to the PA restriction for reporting purposes and also for subsequent claim matching analysis.

Additionally, the Jul. 15, 2011 claim is identified as a would be denied claim because the requested quantity exceeds the quantity limit imposed by the formulary. If the particular implementation of the system is using the optional eligibility window, then the QL restriction will operate to deny the claim or, if possible, to limit the amount being purchased to 30 or less. However, if the particular implementation of the system is not using the optional eligibility window, then the system will analyze the member's claim history and based upon the presence of the allowed claim from Apr. 15, 2011 with a quantity of 90, the system overrides the Jul. 15, 2011 would be denied claim and approves the claim with a quantity of 90. Accordingly, depending on the prescription drug benefit programs preferences and configuration of the particular implementation of the system, the Jul. 15, 2011 claim can be denied altogether, approved but only for the limited quantity of 30 or approved at the requested quantity of 90. In this fashion, the system provides prescription drug benefit programs a significant amount of operational flexibility.

At this point, it should be noted that various alternative implementations of the system may employ many different modules that provide different features and functionality that can be employed by a prescription drug benefit program. Accordingly, depending on the prescription drug benefit programs preferences and configuration of the particular implementation of the system, the would be denied claim overriding functionality is integrated into the claims adjudication system and successfully interoperates with the other modules of the system.

In one embodiment, the override module 65 (FIG. 2) operates alongside a transition of care (“TOC”) module (not shown in any figure) that implements the Centers for Medicare & Medicaid Services (“CMS”) guidelines for reducing abrupt impacts on availability of drugs to members when formularies are changed. For example, the TOC module may analyze a would be denied claim and determine that denial of the would be denied claim meets the CMS transition of care guidelines. In contrast, the override module 65 may analyze the same would be denied claim and based upon an analysis of the member's claim history override the would be denied claim so that the claim is adjudicated as allowed. Accordingly, the override module 65 and the related would be denied claim overriding functionality is integrated into the claims adjudication system and successfully interoperates with the other modules of the system such as the TOC module. Those skilled in the art will understand what additional modules may interface with the would be denied claim overriding functionality in the operation of the claims adjudication system.

FIG. 7 is a flow diagram illustrating an example process for overriding the tier level of an approved claim according to an embodiment of the invention. In one embodiment, the illustrated process can be implemented by the system previously described with respect to FIGS. 1 and 2. Initially, in step 400 the system determines the initial tier at which the allowed claim is to be adjudicated using the current formulary. Next, in step 405 the system performs the tier crosswalk to analyze the possible alternative tiers at which the claim might be adjudicated using one or more prior versions of the formulary. Next, in step 410 the system determines if the initial tier or one of the alternative tiers is preferred. The rules for determining preference can advantageously be based upon settings that are customizable by the prescription drug benefits program. This provides additional flexibility to the prescription drug benefits programs and allows for a program to provide greater benefits to members or greater benefits to employers or other entities.

If the system determines in step 410 that there will not be a tier change, then the allowed claim is adjudicated at the initial tier as shown in step 415. If the system determines in step 410 that there will be a tier change, then the allowed claim is overridden and adjudicated at one of the one or more new tiers as shown in step 420. Because formulary changes are infrequent, there is typically only one alternative tier that could be used for adjudicating the claim. However, in one embodiment a series of formulary changes may result in a plurality of alternative tiers from which to select the preferred tier at which the allowed claim is adjudicated.

FIGS. 8A-8D are block diagrams illustrating examples of overriding the tier level of an approved claim according to an embodiment of the invention. In FIG. 8A a two tier plan that was in place in 2010 is replaced with a five tier plan for 2011. When analyzing claims in accordance with the formulary change shown in FIG. 8A, the system uses the tier crosswalk 440 to determine if the history claim tier (i.e., using the 2010 formulary) or the current claim tier (i.e., using the current 2011 formulary) is preferable. In this case, preferable means less costly to the member. Based on the tier mapping 445 of the respective formularies, the system will override the current tier level when the historical tier level is higher than the current tier level. If the tier levels are equivalent or the current tier level is lower, then the system will not override the tier level.

In FIG. 8B a four tier plan that was in place in 2010 is replaced with a five tier plan for 2011. When analyzing claims in accordance with the formulary change shown in FIG. 8B, the system uses the tier crosswalk 450 to determine if the history claim tier (i.e., using the 2010 formulary) or the current claim tier (i.e., using the current 2011 formulary) is preferable. Again, preferable means less costly to the member. Based on the tier mapping 455 of the respective formularies, the system will override the current tier level when the historical tier level is higher than the current tier level. If the tier levels are equivalent or the current tier level is lower, then the system will not override the tier level.

In FIG. 8C a four tier plan that was in place in 2010 is replaced with a two tier plan for 2011. When analyzing claims in accordance with the formulary change shown in FIG. 8C, the system uses the tier crosswalk 460 to determine if the history claim tier (i.e., using the 2010 formulary) or the current claim tier (i.e., using the current 2011 formulary) is preferable. Once again, preferable means less costly to the member. Based on the tier mapping 465 of the respective formularies, the system will override the current tier level when the historical tier level is higher than the current tier level. If the tier levels are equivalent or the current tier level is lower, then the system will not override the tier level.

In FIG. 8D a four tier plan that was in place in 2010 is replaced with a four tier plan for 2011. The difference in the 2010 and 2011 plans is that in 2010, specialty drugs had a lower tier than non-preferred brand drugs while in 2011 non-preferred brand drugs enjoyed a lower tier than specialty drugs. When analyzing claims in accordance with the formulary change shown in FIG. 8D, the system uses the tier crosswalk 470 to determine if the history claim tier (i.e., using the 2010 formulary) or the current claim tier (i.e., using the current 2011 formulary) is preferable. Yet again, preferable means less costly to the member. Based on the mapping of tier levels in crosswalk 475, the system will override the current tier level when the historical tier level is higher than the current tier level. If the tier levels are equivalent or the current tier level is lower, then the system will not override the tier level.

FIG. 9 is a block diagram illustrating an example wired or wireless system 550 that may be used in connection with various embodiments described herein. For example, referring to FIG. 1, the system 550 may be used as or in conjunction with a device at the pharmacy 20 or the PBM 30 to facilitate wired or wireless communication over network 40. The system 550 can be a conventional personal computer, computer server, personal digital assistant, smart phone, tablet computer, or any other processor enabled device that is capable of wired or wireless data communication. Other computer systems and/or architectures may be also used, as will be clear to those skilled in the art.

The system 550 preferably includes one or more processors, such as processor 560. Additional processors may be provided, such as an auxiliary processor to manage input/output, an auxiliary processor to perform floating point mathematical operations, a special-purpose microprocessor having an architecture suitable for fast execution of signal processing algorithms (e.g., digital signal processor), a slave processor subordinate to the main processing system (e.g., back-end processor), an additional microprocessor or controller for dual or multiple processor systems, or a coprocessor. Such auxiliary processors may be discrete processors or may be integrated with the processor 560.

The processor 560 is preferably connected to a communication bus 555. The communication bus 555 may include a data channel for facilitating information transfer between storage and other peripheral components of the system 550. The communication bus 555 further may provide a set of signals used for communication with the processor 560, including a data bus, address bus, and control bus (not shown). The communication bus 555 may comprise any standard or non-standard bus architecture such as, for example, bus architectures compliant with industry standard architecture (“ISA”), extended industry standard architecture (“EISA”), Micro Channel Architecture (“MCA”), peripheral component interconnect (“PCI”) local bus, or standards promulgated by the Institute of Electrical and Electronics Engineers (“IEEE”) including IEEE 488 general-purpose interface bus (“GPIB”), IEEE 696/S-100, and the like.

System 550 preferably includes a main memory 565 and may also include a secondary memory 570. The main memory 565 provides storage of instructions and data for programs executing on the processor 560. The main memory 565 is typically semiconductor-based memory such as dynamic random access memory (“DRAM”) and/or static random access memory (“SRAM”). Other semiconductor-based memory types include, for example, synchronous dynamic random access memory (“SDRAM”), Rambus dynamic random access memory (“RDRAM”), ferroelectric random access memory (“FRAM”), and the like, including read only memory (“ROM”).

The secondary memory 570 may optionally include a internal memory 575 and/or a removable medium 580, for example a floppy disk drive, a magnetic tape drive, a compact disc (“CD”) drive, a digital versatile disc (“DVD”) drive, etc. The removable medium 580 is read from and/or written to in a well-known manner. Removable storage medium 580 may be, for example, a floppy disk, magnetic tape, CD, DVD, SD card, etc.

The removable storage medium 580 is a non-transitory computer readable medium having stored thereon computer executable code (i.e., software) and/or data. The computer software or data stored on the removable storage medium 580 is read into the system 550 for execution by the processor 560.

In alternative embodiments, secondary memory 570 may include other similar means for allowing computer programs or other data or instructions to be loaded into the system 550. Such means may include, for example, an external storage medium 595 and an interface 570. Examples of external storage medium 595 may include an external hard disk drive or an external optical drive, or and external magneto-optical drive.

Other examples of secondary memory 570 may include semiconductor-based memory such as programmable read-only memory (“PROM”), erasable programmable read-only memory (“EPROM”), electrically erasable read-only memory (“EEPROM”), or flash memory (block oriented memory similar to EEPROM). Also included are any other removable storage media 580 and communication interface 590, which allow software and data to be transferred from an external medium 595 to the system 550.

System 550 may also include a communication interface 590. The communication interface 590 allows software and data to be transferred between system 550 and external devices (e.g. printers), networks, or information sources. For example, computer software or executable code may be transferred to system 550 from a network server via communication interface 590. Examples of communication interface 590 include a modem, a network interface card (“NIC”), a wireless data card, a communications port, a PCMCIA slot and card, an infrared interface, and an IEEE 1394 fire-wire, just to name a few.

Communication interface 590 preferably implements industry promulgated protocol standards, such as Ethernet IEEE 802 standards, Fiber Channel, digital subscriber line (“DSL”), asynchronous digital subscriber line (“ADSL”), frame relay, asynchronous transfer mode (“ATM”), integrated digital services network (“ISDN”), personal communications services (“PCS”), transmission control protocol/Internet protocol (“TCP/IP”), serial line Internet protocol/point to point protocol (“SLIP/PPP”), and so on, but may also implement customized or non-standard interface protocols as well.

Software and data transferred via communication interface 590 are generally in the form of electrical communication signals 605. These signals 605 are preferably provided to communication interface 590 via a communication channel 600. In one embodiment, the communication channel 600 may be a wired or wireless network, or any variety of other communication links. Communication channel 600 carries signals 605 and can be implemented using a variety of wired or wireless communication means including wire or cable, fiber optics, conventional phone line, cellular phone link, wireless data communication link, radio frequency (“RF”) link, or infrared link, just to name a few.

Computer executable code (i.e., computer programs or software) is stored in the main memory 565 and/or the secondary memory 570. Computer programs can also be received via communication interface 590 and stored in the main memory 565 and/or the secondary memory 570. Such computer programs, when executed, enable the system 550 to perform the various functions of the present invention as previously described.

In this description, the term “computer readable medium” is used to refer to any non-transitory computer readable storage media used to provide computer executable code (e.g., software and computer programs) to the system 550. Examples of these media include main memory 565, secondary memory 570 (including internal memory 575, removable medium 580, and external storage medium 595), and any peripheral device communicatively coupled with communication interface 590 (including a network information server or other network device). These non-transitory computer readable mediums are means for providing executable code, programming instructions, and software to the system 550.

In an embodiment that is implemented using software, the software may be stored on a computer readable medium and loaded into the system 550 by way of removable medium 580, I/O interface 585, or communication interface 590. In such an embodiment, the software is loaded into the system 550 in the form of electrical communication signals 605. The software, when executed by the processor 560, preferably causes the processor 560 to perform the inventive features and functions previously described herein.

The system 550 also includes optional wireless communication components that facilitate wireless communication over a voice and over a data network. The wireless communication components comprise an antenna system 610, a radio system 615 and a baseband system 620. In the system 550, radio frequency (“RF”) signals are transmitted and received over the air by the antenna system 610 under the management of the radio system 615.

In one embodiment, the antenna system 610 may comprise one or more antennae and one or more multiplexors (not shown) that perform a switching function to provide the antenna system 610 with transmit and receive signal paths. In the receive path, received RF signals can be coupled from a multiplexor to a low noise amplifier (not shown) that amplifies the received RF signal and sends the amplified signal to the radio system 615.

In alternative embodiments, the radio system 615 may comprise one or more radios that are configured to communicate over various frequencies. In one embodiment, the radio system 615 may combine a demodulator (not shown) and modulator (not shown) in one integrated circuit (“IC”). The demodulator and modulator can also be separate components. In the incoming path, the demodulator strips away the RF carrier signal leaving a baseband receive audio signal, which is sent from the radio system 615 to the baseband system 620.

If the received signal contains audio information, then baseband system 620 decodes the signal and converts it to an analog signal. Then the signal is amplified and sent to a speaker. The baseband system 620 also receives analog audio signals from a microphone. These analog audio signals are converted to digital signals and encoded by the baseband system 620. The baseband system 620 also codes the digital signals for transmission and generates a baseband transmit audio signal that is routed to the modulator portion of the radio system 615. The modulator mixes the baseband transmit audio signal with an RF carrier signal generating an RF transmit signal that is routed to the antenna system and may pass through a power amplifier (not shown). The power amplifier amplifies the RF transmit signal and routes it to the antenna system 610 where the signal is switched to the antenna port for transmission.

The baseband system 620 is also communicatively coupled with the processor 560. The central processing unit 560 has access to data storage areas 565 and 570. The central processing unit 560 is preferably configured to execute instructions (i.e., computer programs or software) that can be stored in the memory 565 or the secondary memory 570. Computer programs can also be received from the baseband processor 610 and stored in the data storage area 565 or in secondary memory 570, or executed upon receipt. Such computer programs, when executed, enable the system 550 to perform the various functions of the present invention as previously described. For example, data storage areas 565 may include various software modules (not shown) that were previously described with respect to FIGS. 2 and 3.

Various embodiments may also be implemented primarily in hardware using, for example, components such as application specific integrated circuits (“ASICs”), or field programmable gate arrays (“FPGAs”). Implementation of a hardware state machine capable of performing the functions described herein will also be apparent to those skilled in the relevant art. Various embodiments may also be implemented using a combination of both hardware and software.

Furthermore, those of skill in the art will appreciate that the various illustrative logical blocks, modules, circuits, and method steps described in connection with the above described figures and the embodiments disclosed herein can often be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled persons can implement the described functionality in varying ways for each particular application, but such implementation decisions should not be interpreted as causing a departure from the scope of the invention. In addition, the grouping of functions within a module, block, circuit or step is for ease of description. Specific functions or steps can be moved from one module, block or circuit to another without departing from the invention.

Moreover, the various illustrative logical blocks, modules, and methods described in connection with the embodiments disclosed herein can be implemented or performed with a general purpose processor, a digital signal processor (“DSP”), an ASIC, FPGA or other programmable logic device, discrete gate or transistor logic, discrete hardware components, or any combination thereof designed to perform the functions described herein. A general-purpose processor can be a microprocessor, but in the alternative, the processor can be any processor, controller, microcontroller, or state machine. A processor can also be implemented as a combination of computing devices, for example, a combination of a DSP and a microprocessor, a plurality of microprocessors, one or more microprocessors in conjunction with a DSP core, or any other such configuration.

Additionally, the steps of a method or algorithm described in connection with the embodiments disclosed herein can be embodied directly in hardware, in a software module executed by a processor, or in a combination of the two. A software module can reside in RAM memory, flash memory, ROM memory, EPROM memory, EEPROM memory, registers, hard disk, a removable disk, a CD-ROM, or any other form of storage medium including a network storage medium. An exemplary storage medium can be coupled to the processor such the processor can read information from, and write information to, the storage medium. In the alternative, the storage medium can be integral to the processor. The processor and the storage medium can also reside in an ASIC.

The above description of the disclosed embodiments is provided to enable any person skilled in the art to make or use the invention. Various modifications to these embodiments will be readily apparent to those skilled in the art, and the generic principles described herein can be applied to other embodiments without departing from the spirit or scope of the invention. Thus, it is to be understood that the description and drawings presented herein represent a presently preferred embodiment of the invention and are therefore representative of the subject matter which is broadly contemplated by the present invention. It is further understood that the scope of the present invention fully encompasses other embodiments that may become obvious to those skilled in the art and that the scope of the present invention is accordingly not limited.

1. A method for improved processing of claims by a pharmacy benefits manager comprising:
receiving a current claim identifying a healthcare plan and a member of said healthcare plan;
determining that adjudicating the current claim would result in a denied claim;
identifying a prior allowed claim for said member that matches the current claim; and
adjudicating the allowance of the current claim based on the prior allowed claim.

2. The method of claim 1, wherein identifying a prior allowed claim for said member comprises searching a data storage area containing historical claim data.

3. The method of claim 2, further comprising analyzing the current claim to determine one or more parameters of the current claim and comparing said one or more parameters of the current claim to one or more parameters of at least one historical claim in said data storage area.

4. The method of claim 3, wherein the identified prior allowed claim for said member comprises parameters that meet a predetermined threshold for matching the current claim.

5. The method of claim 1, further comprising storing a record of said allowed current claim in a data storage area containing historical claim data.

6. The method of claim 5, further comprising storing in association with the record of said allowed current claim an indication that the claim was overridden.

7. A method for improved processing of claims by a pharmacy benefits manager comprising:
receiving a current claim identifying a healthcare plan and a member of said healthcare plan;
determining that adjudicating the current claim would result in an allowed claim at an initial tier;
identifying a prior allowed claim for said member that matches the current claim, wherein said prior allowed claim was adjudicated at an alternate tier; and
adjudicating the allowance of the current claim at said alternate tier based on the prior allowed claim.

8. The method of claim 7, wherein identifying a prior allowed claim for said member comprises searching a data storage area containing historical claim data.

9. The method of claim 8, further comprising analyzing the current claim to determine one or more parameters of the current claim and comparing said one or more parameters of the current claim to one or more parameters of at least one historical claim in said data storage area.

10. The method of claim 9, wherein the identified prior allowed claim for said member comprises parameters that meet a predetermined threshold for matching the current claim.

11. The method of claim 7, further comprising storing a record of said allowed current claim at said alternate tier in a data storage area containing historical claim data.

12. The method of claim 11, further comprising storing in association with the record of said allowed current claim at said alternate tier an indication that the claim was overridden.

13. A system for improved processing of claims by a pharmacy benefits manager comprising:
one or more non-transitory computer readable media configured to store data and executable programmed modules;
a processor communicatively coupled with the one or more non-transitory computer readable media configured to execute programmed modules stored therein;
a POS module stored in the one or more non-transitory computer readable media and configured to be executed by the processor, the POS module configured to adjudicate a current claim to allow or deny the current claim;
an override module stored in the one or more non-transitory computer readable media and configured to be executed by the processor, the override module configured to determine an expected result of adjudicating a current claim and override the current claim based on a prior allowed claim;
a history module stored in the one or more non-transitory computer readable media and configured to be executed by the processor, the history module configured to identify a prior allowed claim stored in the one or more non-transitory computer readable media that matches the current claim;
wherein the POS module is further configured to adjudicate the allowance of the current claim in accordance with an override of the current claim by the override module based on the prior allowed claim identified by the history module.

14. The system of claim 13, wherein the override module is further configured to identify a matching prior allowed claim by analyzing the current claim to determine one or more parameters of the current claim and comparing said one or more parameters of the current claim to one or more parameters of at least one prior allowed claim stored in the one or more non-transitory computer readable media.

15. The system of claim 14, wherein the identified prior allowed claim comprises parameters that meet a predetermined threshold for matching the current claim.

16. The system of claim 14, wherein said one or more parameters comprise at least a healthcare plan, a member information, and a medication information.

17. The system of claim 13, wherein the override module is further configured to store a record of said allowed current claim in the one or more non-transitory computer readable media.

18. The system of claim 17, wherein the override module is further configured to store in association with the record of said allowed current claim an indication that the claim was overridden.

19. The system of claim 13, wherein the expected result of adjudicating the current claim is an allowed claim at an initial tier, further comprising:
a tier module stored in the one or more non-transitory computer readable media and configured to be executed by the processor, the tier module configured to determine said initial tier at which the current claim would be adjudicated and determine an alternate tier at which the prior claim was adjudicated;
wherein the POS module is further configured to adjudicate the allowance of the current claim at said alternate tier based on the prior allowed claim.

20. The system of claim 19, wherein the override module is further configured to store a record of said allowed current claim at said alternate tier in the one or more non-transitory computer readable media.

21. The system of claim 20, wherein the override module is further configured to store in association with the record of said allowed current claim at said alternate tier an indication that the claim was overridden.
